(19) United States
(12) Patent Application Publication
(10) Pub. No.: US 2014/0006720 A1
(43) Pub. Date: Jan. 2, 2014

(54) DIRECTORY CACHE CONTROL DEVICE, DIRECTORY CACHE CONTROL CIRCUIT, AND DIRECTORY CACHE CONTROL METHOD

(71) Applicant: FUJITSU LIMITED, Kawasaki-shi (JP)

(72) Inventors: Yuka HOSOKAWA, Ota (JP); Makoto HATAIDA, Yokohama (JP); Takaharu ISHIZUKA, Kawasaki (JP); Takashi YAMAMOTO, Kawasaki (JP)

(73) Assignee: FUJITSU LIMITED, Kawasaki-shi (JP)

(21) Appl. No.: 14/018,255

(22) Filed: Sep. 4, 2013

Related U.S. Application Data
(63) Continuation of application No. PCT/JP2011/056308, filed on Mar. 16, 2011.

(51) Int. Cl. G06F 12/08

(52) U.S. Cl. CPC G06F 12/0815
USPC 711/141

(57) ABSTRACT

A directory cache control device includes a cache unit, a detection unit, a holding unit, a determination unit, and a control unit. The cache unit caches a directory indicating an information processing apparatus caching information that is stored in a memory. The detection unit detects an error in the directory in the cache unit. The holding unit holds a memory address of the memory where information associated with the directory where the error is detected is stored. The determination unit determines whether a memory address that is a target of the read request and the address that is being held by the holding unit match each other or not. The control unit controls coherency of the information that is a target of the read request, based on a directory of the information that is the target of the read request.

### CROSS-REFERENCE TO RELATED APPLICATION

This application is a continuation of International Application No. PCT/JP2011/056308, filed on Mar. 16, 2011 and designating the U.S., the entire contents of which are incorporated herein by reference.

### FIELD

The embodiment discussed herein is related to a directory cache control device, a directory cache control circuit, and a directory cache control method.

### BACKGROUND

Conventionally, a technology is known according to which a plurality of nodes, each including a memory and a processor including a cache memory, exchange data with one another. There is known, as an example of such a node, a technology of transmitting, in a case a read request for data is received from a processor of another node, data that is stored in the memory of the self device to the processor which is the request source, and causing the transmitted data to be cached in the processor which is the request source.

Such a node has to prevent incoherence between data stored in the memory of the self device and data cached by the processor which is the request source. Accordingly, the node performs coherency processing of maintaining the consistency between the data stored in the memory and the data that is cached, by using a directory indicating the processor which has cached the data. As an example of the node that performs such coherency processing, there is known a node that includes a directory cache for reducing the time of searching for a directory in the memory, and that performs the coherency processing using the directory cached in the directory cache.

FIG. 6 is a diagram for describing an example of the directory cache. In the example illustrated in FIG. 6, the upper address of a memory address where data of a directory is stored is stored in the range in each cache line in the directory cache indicated by (A) in FIG. 6. Also, status information indicating the relationship between directory data of the cache source and the directory data which has been cached is stored in the range indicated by (B) in FIG. 6. Furthermore, the directory data is stored in the range indicated by (C) in FIG. 6. Additionally, the upper address of a memory address where directory data is stored and the status information are associated, as tag information, with directory data stored in the same cache line.

A node having such a directory cache stores the directory data and the tag information in a cache line corresponding to a lower address (an index) of the memory address where the data of the directory is stored. For example, in the example illustrated in FIG. 6, pieces of directory data “A” to “D” stored at memory addresses with the same index and different upper addresses are stored in different WAYs in the same cache line.

In the following, a process performed by a related node is described with reference to FIG. 7. FIG. 7 is a flow chart for describing the flow of a process to be performed by a related node. For example, in the case a read request for data is received from a processor (step S1), the node determines whether the directory is valid or not (step S2). Also, in the case of determining that the directory is valid (step S2: Yes), the node searches the directory cache for directory data of data which is the target of the read request (step S3).

Here, the node determines whether an error has occurred in the tag information (step S4), and in the case no error is determined to have occurred in the tag information (step S4: No), determines whether there is a cache hit on the directory or not (step S5). Also, in the case there is a cache hit on the directory data (step S5: Yes), the node issues a snoop using the directory data where the cache hit has occurred, and maintains coherency of data.

That is, the node identifies a processor for which a snoop is to be issued from the directory data where the cache hit has occurred, and issues a snoop to the identified processor (step S6). Then, the node maintains the consistency between the data to be cached by the processor to which the snoop is issued and the data stored in the memory of the self device, transmits the data to the processor which is the request source (step S7), and ends the process.

Also, in the case there is no cache hit on the directory data (step S5: No), the node reads the directory data from the memory (step S10), and stores the directory data in the directory cache (step S11). Then, the node identifies a processor to which a snoop is to be issued, and issues a snoop to the identified snoop (step S12).

Here, in the case an error occurs in the directory stored in the directory cache, the node may cache the directory with the error again using the tag information. However, in the case there is an error in the tag information of the directory cache, the node is difficult to identify the directory associated with the tag information where the error has occurred. For example, in the case an error has occurred in the tag information indicated by (D) in FIG. 6, the node is difficult to identify the directory data with the error among the pieces of directory data “A” to “D” stored at the memory address having the same index.

Accordingly, in the case an error has occurred in the tag information of the directory cache (step S4: Yes), the node determines that the directory is not to be used, and invalidates the directory (step S8). Then, the node performs broadcast of issuing a snoop to all the processors (step S9). Also, in the case a read request is newly received from another node (step S1), the node determines that the directory is not valid (step S2: No). Thus, the node issues a snoop to all the processors of other nodes (step S9).

Patent Document 1: Japanese Laid-open Patent Publication No. 10-320279

Patent Document 2: Japanese Patent No. 3239935

However, according to the above-described technology of stopping the use of a directory in the case an error has occurred in the tag of the directory cache, a snoop is issued to all the processors of other nodes every time a read request is received. Accordingly, there is a problem that the amount of communication between nodes becomes large, and the performance of the parallel computing system is reduced.

### SUMMARY

According to an aspect of the embodiments, a directory cache control device includes: a cache unit that caches a directory indicating an information processing apparatus caching information that is stored in a memory; a detection unit that detects an error in the directory in the cache unit; a holding unit that holds, in a case an error is detected by the detection unit, a memory address of the memory where information associated with the directory where the error is detected is stored; a determination unit that determines, in a case a read request for information stored in the memory is received, whether a memory address that is a target of the read request and the address that is being held by the holding unit match each other or not; and a control unit that controls, in a case the memory address that is the target of the read request and the address that is being held by the holding unit are determined by the determination unit not to match each other, coherency of the information that is a target of the read request, based on a directory of the information that is the target of the read request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a parallel computing system according to a first embodiment;

FIG. 2 is a diagram for describing directory data;

FIG. 3 is a diagram for describing a process of a directory cache control circuit for searching for directory data;

FIG. 4 is a diagram for describing a process to be performed by the directory cache control circuit;

FIG. 5 is a flow chart for describing a flow of a process to be performed by a node controller;

FIG. 6 is a diagram for describing an example of a directory cache; and

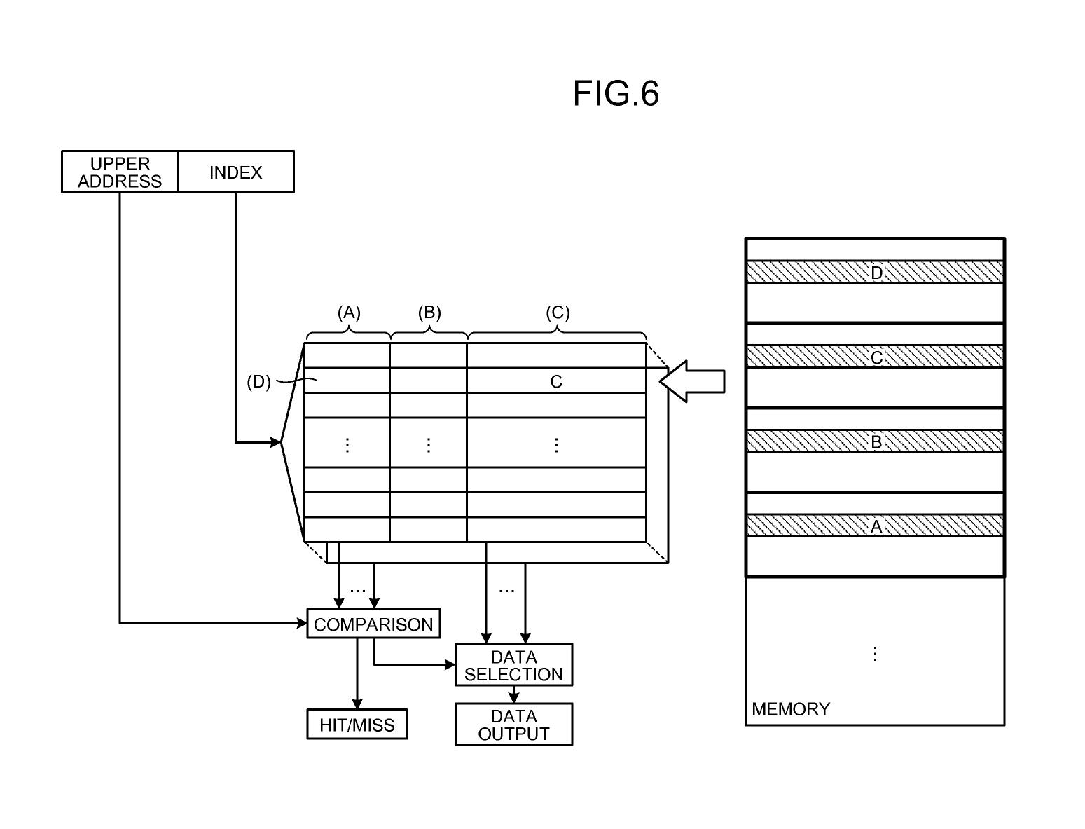

FIG. 7 is a flow chart for describing a flow of a process to be performed by a related node.

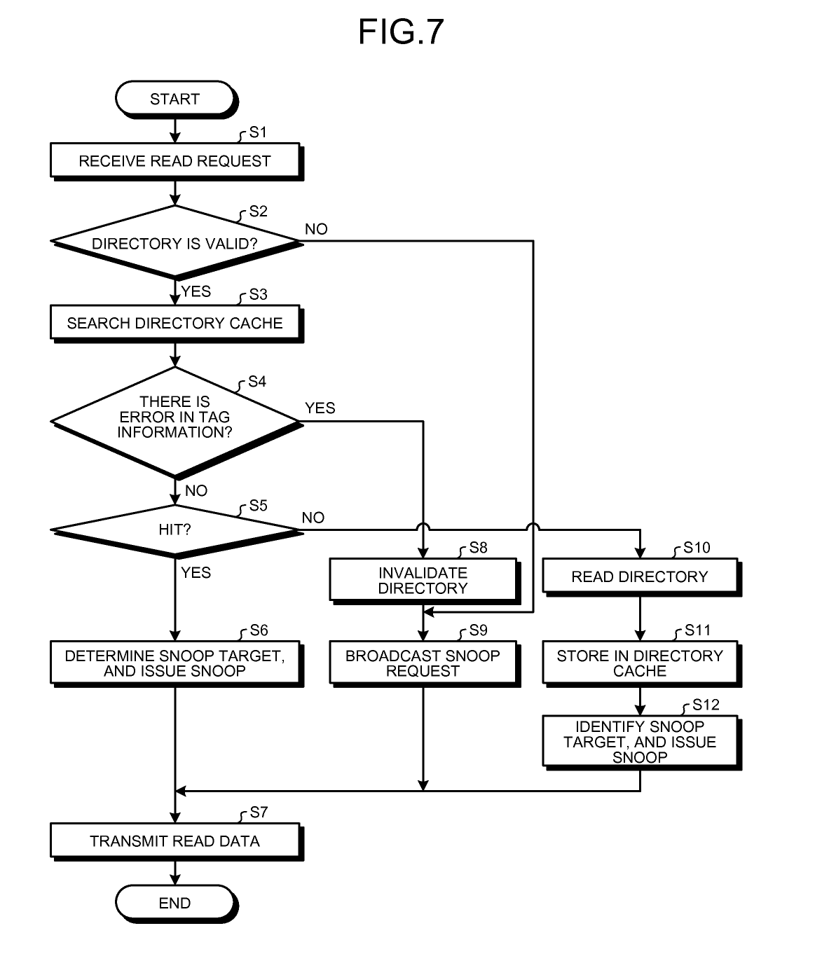

### DESCRIPTION OF EMBODIMENTS

Preferred embodiments will be explained with reference to accompanying drawings.

### [a] First Embodiment

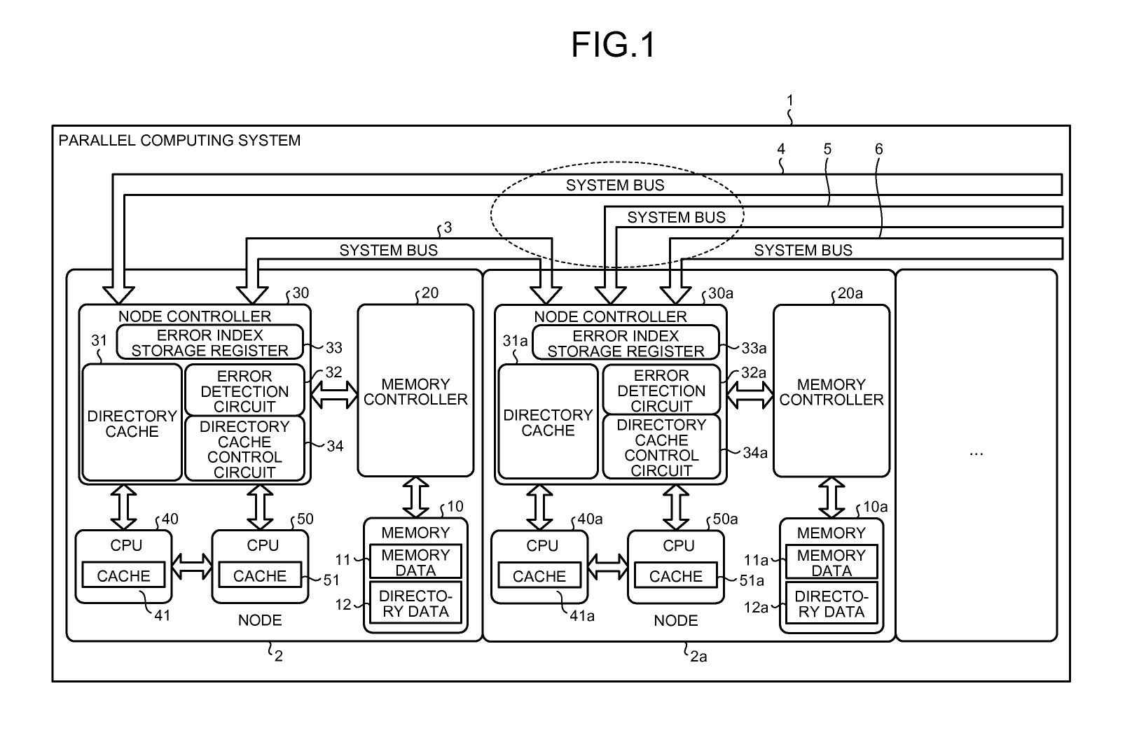

In a first embodiment below, an example of a parallel computing system where a plurality of nodes, each including a directory cache control device, are connected by system buses will be described with reference to FIG. 1. FIG. 1 is a diagram for describing the parallel computing system according to the first embodiment.

As illustrated in FIG. 1, a parallel computing system 1 includes a node 2 and a node 2a having the same structure. Also, although omitted from FIG. 1, the parallel computing system 1 further includes a plurality of nodes having the same structure as the node 2. Furthermore, the nodes are connected to one another by system buses 3 to 6. In the following description, each unit of the node 2 will be described, and description about other nodes will be omitted.

The node 2 includes a memory 10, a memory controller 20, a node controller 30, a CPU (Central Processing Unit) 40, and a CPU 50. The memory 10 stores memory data 11, and directory data 12. The node controller 30 includes a directory cache 31, an error detection circuit 32, an error index storage register 33, and a directory cache control circuit 34. Additionally, in addition to the units 31 to 34 illustrated in FIG. 1, the node controller 30 includes circuits for controlling the function of controlling communication between the node 2 and other nodes, and for controlling the function of the node 2.

The memory 10 stores the memory data 11, and the directory data 12. Specifically, the memory 10 is, logically, divided into two regions. The memory data 11, which is data which is the target of a read request, is stored in one region, and the directory data 12, which is information indicating a CPU caching each piece of memory data 11, is stored in the other region. Moreover, the region where each piece of directory data 12 is stored is assigned with the same memory address as the memory address where the associated memory data 11 is stored. That is, the memory data 11 and the directory data 12 are stored in regions assigned with the same memory address.

Additionally, in the following, a description is given assuming that the same memory address is assigned to the regions where the memory data 11 and the directory data 12 are stored, but the embodiment is not limited to such.

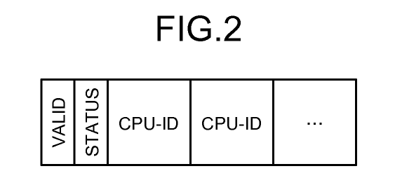

FIG. 2 is a diagram for describing the directory data. As illustrated in FIG. 2, the directory data 12 stores bits indicating, from the top, “Valid”, “Status”, and “CPU-ID”. Here, a valid bit indicating whether the data of the directory data 12 is valid or not is stored in “Valid”. Also, information indicating the consistency between the memory data 11 stored in the memory 10 and the memory data 11 that is cached is stored in “Status”. Furthermore, an identifier indicating the CPU caching the associated memory data 11 is stored in “CPU-ID”.

For example, one of “M: Modify”, “E: Exclusive”, “S: Shared”, and “I: Invalid” is stored in “Status”. Here, “M” indicates that the CPU indicated by the identifier stored in “CPU-ID” has exclusively cached the memory data 11, and the cached memory data 11 is updated to a latest state where it has been rewritten (dirty).

Also, “E” indicates that the CPU indicated by the identifier stored in “CPU-ID” has exclusively cached the memory data 11, and the cached memory data 11 is in a state where it is not rewritten (clean). Furthermore, “S” indicates a state where a plurality of CPUs indicated by the identifiers stored in “CPU-ID” have cached the same memory data 11. Moreover, “I” indicates that the data that is cached is invalid.

Returning to FIG. 1, the memory controller 20 controls the memory data 11 and the directory data 12 stored in the memory 10. Specifically, in the case a memory address is acquired from the node controller 30, the memory controller 20 acquires, from the memory 10, the memory data 11 stored at the acquired memory address. Then, the memory controller 20 transmits the acquired memory data 11 to the node controller 30.

Also, in the case a memory address indicating that the directory data 12 is to be acquired is acquired from the node controller 30, the memory controller 20 acquires, from the memory 10, the directory data 12 stored at the acquired memory address. Then, the memory controller 20 transmits the acquired directory data 12 to the node controller 30.

Moreover, in the case new memory data 11 and a memory address are acquired from the node controller 30, the memory controller 20 updates the memory data 11 stored at the acquired memory address to the new memory data 11. Also, in the case new directory data 12 and a memory address are acquired from the node controller 30, the memory controller 20 updates the directory data 12 stored at the acquired memory address to the new directory data 12.

The node controller 30 caches the directory data 12 stored in the memory 10, via the memory controller 20. Also, the node controller 30 detects an error in the cached directory data 12. Moreover, in the case an error is detected, the node controller 30 holds the lower address (index) of the memory address where the memory data 11 associated with the directory data 12 with the detected error is stored.

Then, in the case a read request for memory data is received from the CPU, the node controller 30 searches the directory cache 31 for the index of the memory address which is the target of the read request. Also, in the case a cache miss occurs when the index is searched for in the directory cache 31, the node controller 30 determines whether or not the index of the memory address which is the target of the read request matches the index that is being held. Then, in the case it is determined that the index of the memory address which is the target of the read request and the index that is being held do not match, the node controller 30 performs the following process. That is, the node controller 30 controls the coherency of the memory data which is the target of the read request, based on the directory data 12 of the memory data 11 which is the target of the read request. Then, the node controller 30 transmits information which is the target of the read request to the CPU which is the request source.

In the following, each unit of the node controller 30 will be described. The directory cache 31 caches the directory data 12 indicating the CPU caching information stored in the memory 10. Also, the directory cache 31 caches, as the tag information, the upper address of the memory address where the directory data 12 is stored and status information indicating the state of the directory data 12 in association with the directory data 12.

Furthermore, the directory cache 31 includes a plurality of cache lines associated with the lower addresses of the memory addresses in the memory 10. Moreover, the directory cache 31 includes a plurality of WAYs in each cache line. That is, the directory cache 31 is a multi-way cache memory. The directory cache 31 thus stores a plurality of pieces of directory data 12 stored at memory addresses with the same index in different WAYs in the same cache line.

The error detection circuit 32 detects an error which has occurred in the directory cache 31. For example, the error detection circuit 32 detects an error in each WAY stored in the cache line, among the directory data 12 included in the directory cache 31, which is the target of search by the directory cache control circuit 34. Then, in the case an error which has occurred in the tag information is detected, the error detection circuit 32 notifies the directory cache control circuit 34 of the WAY in the cache line where the tag information with the detected error is stored. Additionally, the error detection circuit 32 may detect an error by any method.

In the case the error in the tag information is detected by the error detection circuit 32, the error index storage register 33 holds the index of the memory address where the directory data 12 associated with the tag information with the detected error is stored. That is, the directory cache control circuit 34 stores, in the error index storage register 33, the index of the memory address where the directory data 12 associated with the tag information with the detected error is stored.

In the case a read request for the memory data 11 is received, the directory cache control circuit 34 determines whether the index of the memory address which is the target of the read request and the index stored in the error index storage register 33 match each other or not. Then, in the case the index of the memory address which is the target of the read request and the index stored in the error index storage register 33 do not match, the directory cache control circuit 34 performs the following process. That is, the directory cache control circuit 34 issues a snoop to the CPU indicated by the directory data 12 associated with the memory data 11 which is the target of the read request, and controls the coherency of the memory data 11 which is the target of the read request.

Furthermore, in the case the index of the memory address which is the target of the read request and the index stored in the error index storage register 33 match each other, the directory cache control circuit 34 performs the following process. That is, a snoop is broadcasted to all the CPUs in the parallel computing system 1.

Then, the directory cache control circuit 34 controls the coherency of the memory data 11 which is the target of the read request, according to the result of issuance of the snoop. Also, the directory cache control circuit 34 caches the result acquired by the broadcast of the snoop in the directory cache 31.

Moreover, in the case a read request is received again, the directory cache control circuit 34 determines whether the result of the snoop which has been broadcasted is cached in the directory cache 31 or not. Then, in the case it is determined that the result of the snoop which has been broadcasted is cached, the directory cache control circuit 34 issues a snoop to the CPU indicated by the result of the snoop which is cached.

That is, the directory cache 31 is capable of identifying directory data that is not yet cached in the memory 10, with respect to the directory data 12 stored in a cache line where there is no error. Therefore, the node controller 30 determines that the directory data 12 stored in a cache line where there is no error is reliable directory data 12.

Accordingly, the directory cache control circuit 34 stores, in the error index storage register 33, the index of the directory data 12 associated with the tag information where the error has occurred, that is, the index associated with the cache line where the error has occurred. Then, in the case the index of a memory address which is the target of a newly received read request does not match the index stored in the error index storage register 33, the directory cache 31 transmits a snoop using the directory data 12.

That is, the directory cache control circuit 34 transmits the snoop only to the CPU indicated by the directory data 12 stored in the memory 10 or by the directory data 12 stored in the directory cache 31. Accordingly, since also in the case where read requests are successively issued, the node controller 30 does not broadcast a snoop, the amount of communication between the nodes may be reduced. As a result, the parallel computing system 1 may efficiently proceed with the process.

Furthermore, the directory cache control circuit 34 stores the result of the broadcast of the snoop in the directory cache 31. Then, in the case the index of the read request matches the index stored in the error index storage register 33, the directory cache control circuit 34 performs the following process.

That is, the directory cache control circuit 34 searches the directory cache 31 for the result of the snoop which has been broadcasted with respect to the memory data 11 of the memory address which is the target of the read request. Then, in the case the result of the snoop is retrieved, the directory cache control circuit 34 performs snooping only on the CPU indicated by the result of the snoop.

Accordingly, the directory cache control circuit 34 prevents broadcast of a snoop also in the case where there are successive read requests for the memory data 11 with respect to which the directory data 12 is difficult to be used due to occurrence of an error, and the amount of communication between the nodes is reduced. As a result, the parallel computing system 1 may efficiently proceed with the process.

Additionally, if, as a result of issuance of a snoop, the memory data 11 stored in the memory 10 is to be updated to the memory data 11 that is cached in the CPU of another node, the node controller 30 performs the following process. That is, the node controller 30 transmits the new memory address and the new memory data 11 to the memory controller 20. Also, in the case the result of issuance of a snoop indicates that there is a change in the directory data 12, the node controller 30 transmits the memory address and the directory data 12 after change to the memory controller 20.

Moreover, in the case of acquiring the memory data 11 from the memory 10, the node controller 30 transmits the memory address where the memory data 11 is stored to the memory controller 20. Also, in the case of acquiring the directory data 12 from the memory 10, the node controller 30 transmits the memory address where the directory data 12 is stored and a notice that the directory data 12 is to be acquired to the memory controller 20.

The CPU 40 is an information processing apparatus that performs a process using the pieces of memory data 11 and 11a stored in the memories 10 and 10a. Here, the CPU 40 includes a cache 41, and caches the pieces of memory data 11 and 11a stored in the memories 10 and 10a. Also, in the case the node controller 30 has acquired a snoop broadcasted by another node 2a, the CPU 40 determines whether the memory data 11a is cached in the self device from the memory 10a of the node 2a. Then, in the case it is determined that the memory data 11a is cached in the self device, the CPU 40 transmits a transaction to the node 2a, and maintains the consistency between the memory data 11a cached in the self device and the memory data 11a stored in the memory 10a.

The CPU 50 is an information processing apparatus that includes a cache 51, and that performs a process using the pieces of memory data 11 and 11a stored in the memories 10 and 10a. Additionally, the CPU 50 is assumed to have the same function as the CPU 40, and description thereof is omitted.

For example, the error detection circuit 32 and the directory cache control circuit 34 are electronic circuits. Here, as the electronic circuit, an integrated circuit such as an ASIC (Application Specific Integrated Circuit) or an FPGA (Field Programmable Gate Array), a CPU (Central Processing Unit), an MPU (Micro Processing Unit), or the like is adopted.

Also, the directory cache 31 is a storage device such as a semiconductor memory device such as a RAM (Random Access Memory) or a flash memory. Furthermore, the error index storage register 33 is a register.

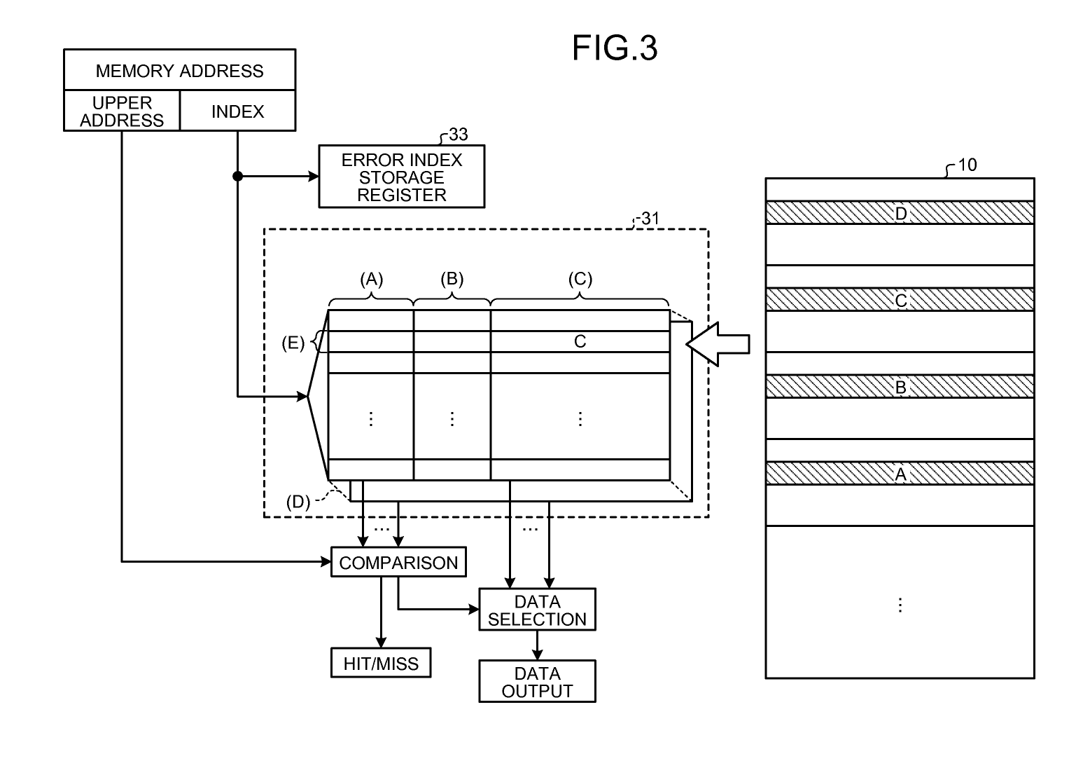

Next, a process of the directory cache control circuit 34 searching the directory cache 31 for cache data will be described with reference to FIG. 3. FIG. 3 is a diagram for describing a process of the directory cache control circuit 34 searching for directory data. Additionally, the upper address of a memory address where the directory data 12 is stored is stored in the range indicated by (A) in FIG. 3. Also, information indicating the state of the directory data 12 is stored in the range indicated by (B) in FIG. 3. Furthermore, the directory data 12 is stored in the range indicated by (C) in FIG. 3. Additionally, the upper address of the memory address where the directory data 12 is stored and the information indicating the state of the directory data 12 are stored, as tag information, in association with the directory data 12.

Furthermore, as indicated by (D) in FIG. 3, the directory cache 31 is a multi-way cache memory. Also, a plurality of pieces of directory data stored at memory addresses with the same index are stored in respective WAYs included in one cache line. For example, in the example illustrated in FIG. 3, a plurality of pieces of directory data “A” to “D” stored at memory addresses with the same index are stored in WAYs included in the same cache line.

Thus, in the case an error is detected in the tag information indicated by (E) in FIG. 3, it is not possible to determine with respect to which of the pieces of directory data “A” to “D” the error has occurred. However, also in the case an error has occurred in the tag information indicated by (E) in FIG. 3, the directory data 12 stored in other cache lines may be assumed to be reliable data.

Accordingly, the directory cache control circuit 34 stores, in the error index storage register 33, the index of the cache line of the tag information with the error. Then, in the case the index of the memory address which is the target of a read request matches the index stored in the error index storage register 33, the directory cache control circuit 34 does not trust the directory data 12. That is, in the case the index of the memory address which is the target of a read request is the index with the error, the directory cache control circuit 34 does not use the directory data 12, and broadcasts a snoop.

On the other hand, in the case the index of the memory address which is the target of a read request is different from the index with the error, the directory cache control circuit 34 trusts the directory data 12 of the memory address which is the target of the read request. That is, in the case the index of the memory address which is the target of a read request does not match the index stored in the error index storage register 33, the directory cache control circuit 34 issues a snoop to the CPU indicated by the directory data 12.

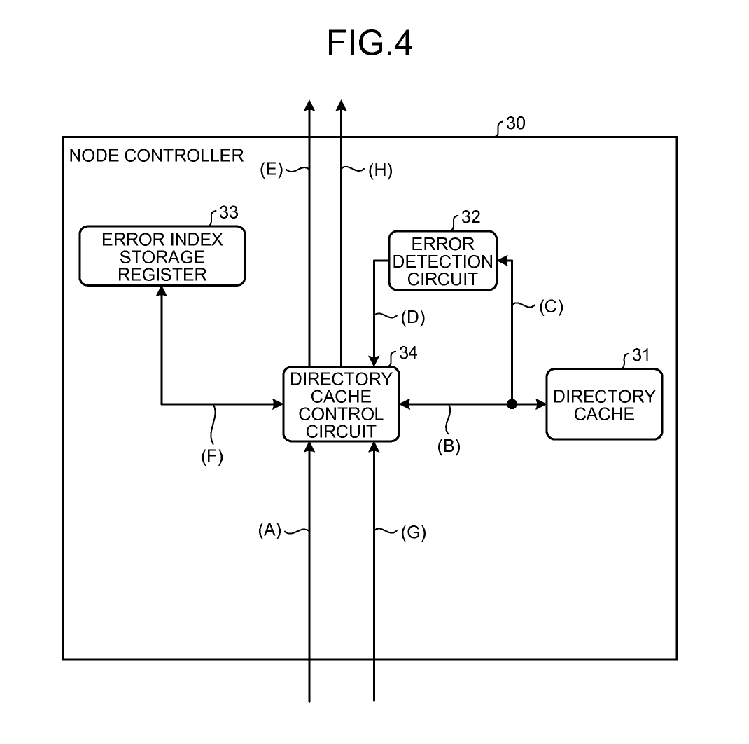

Next, an example of the flow of a process to be performed by the directory cache control circuit 34 will be described with reference to FIG. 4. FIG. 4 is a diagram for describing a process to be performed by the directory cache control circuit 34. For example, as indicated by (A) in FIG. 4, the directory cache control circuit 34 receives a read request from a CPU 40a of the node 2a via the system bus 3. In this case, as indicated by (B) in FIG. 4, the directory cache control circuit 34 searches the directory cache 31 for the directory data 12 stored at the same memory address as the memory address which is the target of the read request.

Here, in the case of searching the directory cache 31 for the directory data 12, the directory cache control circuit 34 identifies the memory address which is the target of the read request which has been received, and determines the upper address and the index from the identified memory address. Then, the directory cache control circuit 34 selects, from the directory cache 31, the cache line associated with the index which has been determined, and acquires the directory data 12 and the tag information stored in each WAY of the selected cache line. Also, the directory cache control circuit 34 compares the upper address of the acquired tag information stored in each WAY and the upper address determined from the memory address which is the target of the read request.

Then, the directory cache control circuit 34 selects the WAY storing the tag information storing the upper address which is the same upper address as that determined from the memory address which is the target of the read request. Then, the directory cache control circuit 34 acquires the directory data 12 cached in the selected WAY. On the other hand, in the case there is no WAY storing the tag information storing the upper address which is the same upper address as that determined from the memory address which is the target of the read request, the directory cache control circuit 34 determines that a cache miss has occurred.

Here, as indicated by (C) in FIG. 4, the error detection circuit 32 determines whether an error has occurred in each WAY of the cache line that the directory cache control circuit 34 has selected from the directory cache 31. Then, as indicated by (D) in FIG. 4, in the case an error is detected in any of the WAYS, the error detection circuit 32 transmits information indicating the WAY where the error is detected to the directory cache control circuit 34. Then, the directory cache control circuit 34 identifies presence or absence of an error and the WAY where the error has occurred, based on the information acquired from the error detection circuit 32.

Furthermore, in the case there is a cache hit, and no error is detected, the directory cache control circuit 34 performs the following process. That is, as indicated by (E) in FIG. 4, the directory cache control circuit 34 checks “Status” stored in the directory data 12 where the cache hit has occurred. Then, in the case “Status” is “M”, the directory cache control circuit 34 issues a snoop to the CPU indicated by “CPU-ID” of the directory data 12 where the cache hit has occurred, as indicated by (E) in FIG. 4.

Also, as indicated by (G) in FIG. 4, after issuing the snoop, the directory cache control circuit 34 receives the latest memory data 11 from the CPU for which the snoop has been issued. Then, as indicated by (H) in FIG. 4, the directory cache control circuit 34 transmits the received memory data 11 to the CPU which is the source of the read request. Moreover, the directory cache control circuit 34 updates the memory data 11 stored in the memory 10. Also, the directory cache control circuit 34 updates “Status” of the directory data 12 where the cache hit has occurred and of the directory data 12 stored in the memory 10.

Furthermore, in the case there is a cache hit, and there is occurrence of an error in the tag information in other than the WAY where the cache hit has occurred, the directory cache control circuit 34 does not trust the directory data 12 where the cache hit has occurred. Thus, as indicated by (F) in FIG. 4, the directory cache control circuit 34 stores the index corresponding to the selected cache line (hereinafter, referred to as the index with an error) in the error index storage register 33. Then, the directory cache control circuit 34 broadcasts a snoop request for the memory data 11 which is the target of the read request.

Here, in the case the CPU caching the memory data 11 which is the target of the read request is determined as a result of broadcast of the snoop request, the directory cache control circuit 34 performs coherency processing with respect to the CPU which has been determined. Then the directory cache control circuit 34 updates the memory data 11, and transmits the updated memory data 11 to the processor which is the request source. Also, the directory cache control circuit 34 stores the result of the broadcast of the snoop in the directory cache 31 together with the upper address of the memory address which is the target of the read request.

Furthermore, in the case of a cache miss, the directory cache control circuit 34 determines whether or not the index of the memory address which is the target of the read request matches the index stored in the error index storage register 33. Then, in the case the index of the memory address which is the target of the read request matches the index stored in the error index storage register 33, the directory cache control circuit 34 performs the following process.

That is, the directory cache control circuit 34 searches among the WAYs of the selected cache line for the WAY storing the tag information storing the address matching the upper address of the memory address which is the target of the read request. Then, the directory cache control circuit 34 issues a snoop only to the CPU indicated by the result of broadcast of a snoop stored in the WAY whose tag information stores the address matching the upper address of the memory address which is the target of the read request. Also, in the case there is no WAY whose tag information stores the address matching the upper address of the memory address which is the target of the read request, the directory cache control circuit 34 broadcasts a snoop request.

On the other hand, in the case the index of the memory address which is the target of the read request does not match the index stored in the error index storage register 33, the directory cache control circuit 34 performs the following process. That is, in the case presence or absence of an error is determined, and no error is detected, the directory cache control circuit 34 causes the directory data 12 to be cached in the directory cache 31 from the memory 10. Then, the directory cache control circuit 34 issues a snoop only to the CPU indicated by the cached directory data 12.

On the other hand, in the case an error is detected, the directory cache control circuit 34 stores the index with the error in the error index storage register 33. Also, the directory cache control circuit 34 broadcasts a snoop request.

The node controller 30 including the units 31 to 34 described above holds the index with an error in the case an error has occurred in the tag information stored in the directory cache 31. Then, in the case the index of the memory address which is the target of a read request is different from the index that is being held, the node controller 30 issues a snoop only to the CPU indicated by the directory data 12 stored in the directory cache 31 or the memory 10.

Accordingly, the node controller 30 may perform appropriate coherency processing without broadcasting a snoop every time a read request is received. As a result, the node controller 30 may suppress the amount of communication between nodes, and improve the performance of the parallel computing system 1.

Also, in the case of broadcasting a snoop, the node controller 30 causes the snoop result to be cached in the directory cache 31. Then, in the case the index of the memory address which is the target of the read request is the same as the index that is being held, the node controller 30 searches the directory cache 31 for directory data 12a. Then, the node controller 30 issues a snoop only to the CPU indicated by the directory data 12a.

Accordingly, the node controller 30 issues a snoop only to a specific CPU even in the case read requests are repeatedly issued for the memory data 11 stored at the memory address associated with the cache line where an error has occurred in the tag information. As a result, the node controller 30 may further reduce the amount of communication between nodes, and improve the performance of the parallel computing system 1.

Additionally, any method may be used as the method of storing the result of a snoop which has been broadcasted in the directory cache 31, but in this embodiment, the upper address of the memory address which is the snoop target and the result of the snoop are stored in the directory cache 31 in association with each other.

<Flow of Process of Node Controller 30>

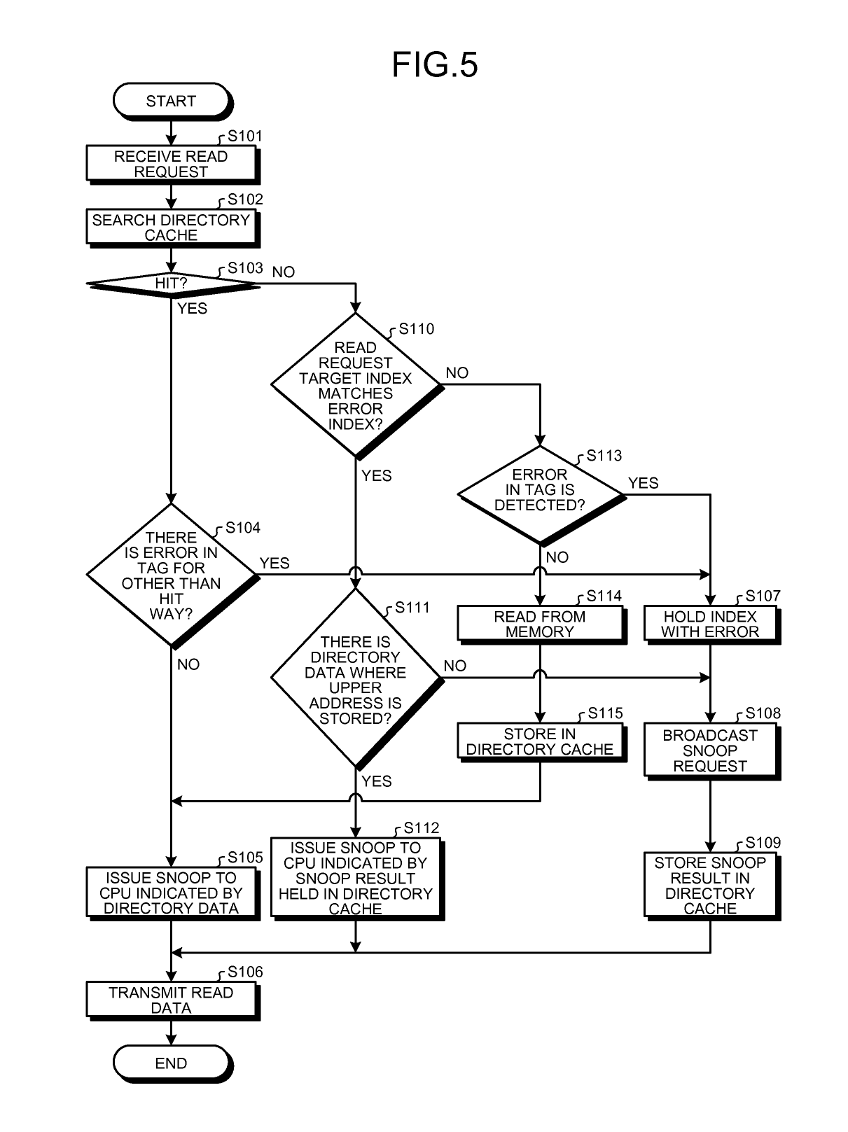

Next, the flow of a process to be performed by the node controller 30 will be described with reference to FIG. 5. FIG. 5 is a flow chart for describing the flow of a process to be performed by the node controller. For example, the node controller 30 starts the process with the reception of a read request from the CPU of another node as the trigger (step S101).

Next, the node controller 30 searches the directory cache 31 for the directory data 12 of the memory data 11 which is the target of the read request (step S102). Then, the node controller 30 determines whether there is a cache hit or not (step S103), and in the case there is a cache hit (step S103: Yes), determines whether an error is detected in the tag information for other than the hit WAY or not (step S104).

Next, in the case no error is detected in the tag information for other than the hit WAY (step S104: No), the node controller 30 issues a snoop to the CPU indicated by the directory data 12 where the cache hit has occurred (step S105). Then, the node controller 30 issues a snoop, and transmits, to the CPU which is the request source, the memory data 11 whose consistency is maintained by the performance of coherency processing (step S106), and ends the process.

On the other hand, in the case an error is detected in the tag information for other than the hit WAY (step S104: Yes), the node controller 30 holds the index with the error in the error index storage register 33 (step S107). Also, the node controller 30 broadcasts a snoop request (step S108), and stores the snoop result in the directory cache 31 (step S109).

Furthermore, in the case there is no cache hit (step S103: No), the node controller 30 performs the following process. That is, node controller 30 determines whether or not the read request target index and the error index match each other (step S110). Then, in the case the read request target index and the error index are determined to match each other (step S110: Yes), the node controller 30 performs the following process. That is, the node controller 30 determines whether the upper address of the memory address which is the target of the read request hits in the directory cache 31 or not (step S111).

Then, in the case the upper address is not hit in the directory cache 31 (step S111: Yes), the node controller 30 issues a snoop to the CPU indicated by the result of the broadcasted snoop which is being held in the directory cache 31 in association with the upper address (step S112). Then, the node controller 30 issues a snoop, and transmits, to the CPU which is the request source, the memory data 11 whose consistency is maintained by the performance of coherency processing (step S106), and ends the process.

Furthermore, in the case the upper address is not hit in the directory cache 31 (step S111: No), the node controller 30 broadcasts a snoop request (step S108). Then, the node controller 30 stores the result of the snoop in the directory cache 31 (step S109).

Moreover, in the case the read request target index does not match the error index (step S110: No), the node controller 30 determines whether an error is detected in the tag information or not (step S113). Then, in the case an error is detected in the tag information (step S113: Yes), the node controller 30 stores the index with the error in the error index storage register 33 (step S107). On the other hand, in the case no error is detected in the tag information (step S113: No), the node controller 30 reads the directory data 12 from the memory 10 (step S114). Then, the node controller 30 stores the directory data 12 which has been read in the directory cache 31 (step S115). Then, the node controller 30 issues a snoop to the CPU indicated by the directory data 12 stored in the directory cache 31 (step S105).

<Effect of First Embodiment>

As described above, in the case an error in the tag information in the directory cache 31 is detected, the node controller 30 stores the index with the error in the error index storage register 33. Also, in the case a read request is acquired, the node controller 30 determines whether the read request target index matches the index stored in the error index storage register 33 or not. Then, in the case the read request target index and the index with the error do not match each other, the node controller 30 controls the coherency of the memory data 11 based on the directory data 12 associated with the memory data 11 which is the target of the read request.

Accordingly, in the case a read request for a memory including an index other than the index with the error is received, the node controller 30 controls the coherency using the directory data 12. That is, the node controller 30 can control the coherency based on the directory data 12 without broadcasting a snoop. As a result, the node controller 30 may reduce the amount of communication between nodes, and improve the performance of the parallel computing system 1.

Furthermore, in the case the read request target index and the index stored in the error index storage register 33 do not match each other, the node controller 30 issues a snoop to the CPU indicated by the directory data 12. Thus, the node controller 30 may appropriately maintain the coherency of the memory data 11 without broadcasting a snoop at the time of receiving the read request, and the amount of communication between nodes may be reduced, and the performance of the parallel computing system 1 may be improved.

Also, in the case of broadcasting a snoop, the node controller 30 stores the result of the snoop in the directory cache 31. Moreover, in the case the target index of the read request received again and the index stored in the error index storage register 33 match each other, the node controller 30 determines whether the result of broadcast of the snoop is stored in the directory cache 31 or not. Then, in the case it is determined that the result of broadcast of the snoop is stored, the node controller 30 issues a snoop to the CPU indicated by the snoop result. That is, the node controller 30 performs the coherency processing using the result of the snoop stored in the directory cache 31, without using the directory data 12 that is not reliable.

Accordingly, also in the case read requests for a memory address associated with a cache line where the tag information with an error is stored are successively received, the node controller 30 may maintain the coherency without broadcasting a snoop. As a result, the node controller 30 may reduce the amount of communication between nodes, and improve the performance of the parallel computing system 1.

On the other hand, in the case the target index of the read request received again and the index stored in the error index storage register 33 match each other, the node controller 30 searches the directory cache 31 for the memory address which is the target of the read request. Then, in the case a snoop result for the memory address which is the read request target is not cached in the directory cache 31, the node controller 30 broadcasts a snoop to all the CPUs in the parallel computing system 1.

That is, in the case the memory address which is the target of the new read request includes the index with the error, and a snoop result is not cached in the directory cache 31, the node controller 30 broadcasts a snoop. Thus, the node controller 30 does not use unreliable directory data 12 that is stored in the cache line with the tag information where the error has occurred. Accordingly, the node controller 30 may appropriately perform the coherency processing.

Also, the node controller 30 caches, in the directory cache 31, as the tag information, the lower address of the memory address where the memory data 11 associated with the directory data 12 is stored. Then, the node controller 30 detects an error which has occurred. Accordingly, the node controller 30 broadcasts a snoop only in the case there is an error that is difficult to be recovered by the directory data 12 stored in the memory 10 among errors that have occurred in the directory cache 31. As a result, the node controller 30 may suppress the amount of communication between nodes, and improve the performance of the parallel computing system 1.

### [b] Second Embodiment

An embodiment of the present invention has been described above, but the present invention may be carried out according to various embodiments different from the embodiment described above. Accordingly, another embodiment of the present invention will be described below as a second embodiment.

(1) Node of Parallel Computing System

The node 2 described above includes two CPUs, 40 and 50, but the embodiment is not limited to such, and any number of CPUs may be included. Also, the parallel computing system 1 described above includes the node 2a and other nodes having the same structure as the node 2, but the embodiment is not limited to such. For example, each node may have an arbitrary structure as long as the nodes are structured to perform the same process as the process performed by the node controller 30.

(2) Directory Data

The directory data 12 described above is data storing “Valid”, “Status” and “CPU-ID”, but the embodiment is not limited to such. That is, it is sufficient if the directory data 12 stores information indicating the CPU caching the associated memory data 11, and status information indicating the relationship between the memory data 11 that is cached and the memory data 11 that is stored in the memory 10.

Also, in the first embodiment described above, status information according to Illinois protocol is stored as the information stored in “Status”. However, the embodiment is not limited to such, and status information according to any protocol may be stored.

Furthermore, the directory cache control circuit 34 stores the snoop result of broadcast of a snoop in the directory cache 31. However, the embodiment is not limited to such.

For example, the node controller 30 further includes an auxiliary memory that caches the directory data 12 that is stored at a memory address with a directory with an error. Then, the directory cache control circuit 34 stores the snoop result of broadcast of a snoop in the auxiliary memory. Then, in the case the target index of a read request matches the index stored in the error index storage register 33, the directory cache control circuit 34 may issue a snoop using the snoop result stored in the auxiliary memory.

(3) Process of Node Controller

The node controller 30 described above performs the following process in the case the read request target index matches the index stored in the error index storage register 33, so as not to perform broadcast of a snoop as much as possible. That is, the node controller 30 determines whether or not a snoop result of broadcast of a snoop is cached in the directory cache 31. Then, in the case the snoop result is cached in the directory cache 31, the node controller 30 issues a snoop only to the CPU indicated by the directory data 12 that is cached.

However, the embodiment is not limited to such. For example, in the case the read request target index and the index stored in the error index storage register 33 match each other, the node controller 30 may broadcast an instant snoop. According to such a process, the node controller 30 may be easily structured.

Additionally, in the case of caching a snoop result in the directory cache 31, the directory cache control circuit 34 stores the snoop result in a cache line where an error has occurred. However, the embodiment is not limited to such. For example, the directory cache control circuit 34 may store the snoop result in a different WAY in the cache line where the error has occurred, or in a different cache line.

(4) Memory Address

In the first embodiment, the memory data 11 and the directory data 12 are assigned with the same memory address. However, the embodiment is not limited to such. For example, in the case the memory data 11 and associated directory data 12 are assigned with different memory addresses, the directory cache control circuit 34 stores the memory address where the memory data 11 is stored and the memory address where the associated directory data 12 is stored (hereinafter, referred to as a directory address) in association with each other.

Also, the directory cache control circuit 34 stores the directory data 12 in a cache line according to the directory address, among the cache lines in the directory cache 31. Furthermore, in the case an error is detected in the directory cache 31, the directory cache control circuit 34 stores the index of the directory address related to the cache line where the error is detected in the error index storage register 33.

Then, in the case a read request is received, the directory cache control circuit 34 searches for the directory address that is stored in association with the memory address indicated by the read request. Then, the directory cache control circuit 34 determines whether or not the index of the retrieved directory address is stored in the error index storage register 33. Then, in the case the index of the retrieved directory address is stored in the error index storage register 33, the directory cache control circuit 34 broadcasts a snoop without using the directory cache.

Additionally, the process of storing a memory address and an associated directory address in association with each other and performing conversion may be performed by the memory controller 20. By causing the memory controller 20 to perform such a process, the directory cache control circuit 34 may acquire corresponding memory data 11 and directory data 12 simply by requesting the memory controller 20 for the memory data 11 and the directory data 12 using only the memory address of the read request. Installation of the directory cache control circuit 34 is thereby facilitated.

As described above, even if the memory address and the directory address are not the same, the directory cache control circuit 34 may appropriately perform the process, increase the efficiency of communication between nodes, and increase the efficiency of the parallel computing system 1.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A directory cache control device comprising:
a cache unit that caches a directory indicating an information processing apparatus caching information that is stored in a memory;
a detection unit that detects an error in the directory in the cache unit;
a holding unit that holds, in a case an error is detected by the detection unit, a memory address of the memory where information associated with the directory where the error is detected is stored;
a determination unit that determines, in a case a read request for information stored in the memory is received, whether a memory address that is a target of the read request and the address that is being held by the holding unit match each other or not; and
a control unit that controls, in a case the memory address that is the target of the read request and the address that is being held by the holding unit are determined by the determination unit not to match each other, coherency of the information that is a target of the read request, based on a directory of the information that is the target of the read request.

2. The directory cache control device according to claim 1,
wherein the holding unit holds a lower address of the memory address, and
wherein the determination unit determines whether a lower address of a memory address that is a target of the received read request and the lower address that is being held by the holding unit match each other or not.

3. The directory cache control device according to claim 2,
wherein the directory indicates an information processing apparatus caching associated information, and
wherein in a case the lower address of the memory address that is the target of the read request and the lower address that is being held by the holding unit are determined by the determination unit not to match each other, the control unit issues a snoop for the information processing apparatus indicated by the directory of the information that is the target of the read request.

4. The directory cache control device according to claim 3, wherein in a case the lower address of the memory address that is the target of the read request and the lower address that is being held by the holding unit are determined by the determination unit to match each other, the control unit issues a snoop to all information processing apparatuses capable of caching the information stored in the memory, and caches a result of issuance of the snoop in the cache unit.

5. The directory cache control device according to claim 4, wherein in a case the lower address of the memory address that is the target of the read request and the lower address that is being held by the holding unit are determined by the determination unit to match each other, the control unit determines whether the result of issuance of the snoop to all the information processing apparatuses is stored in the cache unit or not, and in a case the result of issuance of the snoop is stored in the cache unit, issues a snoop to an information processing apparatus indicated by the result of issuance of the snoop.

6. The directory cache control device according to claim 4, wherein in a case the lower address of the memory address that is the target of the read request and the lower address that is being held by the holding unit are determined by the determination unit to match each other, the control unit searches the cache unit for the result of issuance of the snoop to all the information processing apparatuses, and in a case the result of issuance of the snoop is determined to be not cached in the cache unit, issues a snoop to all information processing apparatuses capable of caching the information stored in the memory.

7. The directory cache control device according to claim 1,
wherein the cache unit caches tag information including a lower address of a memory address where information associated with a directory of a cache source is stored, in association with the directory, and
wherein the detection unit detects an error that has occurred in the tag information.

8. A directory cache control circuit comprising:
a cache unit that caches a directory indicating an information processing apparatus caching information that is stored in a memory;
a detection unit that detects an error in the directory that has occurred in the cache unit;
a holding unit that holds, in a case an error is detected by the detection unit in tag information, a predetermined lower address of a memory address of the memory where information associated with the directory where the error has been detected is stored;
a determination unit that determines, in a case a read request for information stored in the memory is received, whether a lower address of a memory address that is a target of the read request and the lower address that is being held by the holding unit match each other or not; and
a control unit that controls, in a case the lower address of the memory address that is the target of the read request and the lower address that is being held by the holding unit are determined by the determination unit not to match each other, coherency of the information that is a target of the read request, based on a directory of the information that is the target of the read request.

9. A directory cache control method to be performed by a directory cache control device including a cache device that caches a directory indicating an information processing apparatus caching information stored in a memory, the directory cache control method comprising:
detecting an error in the directory that has occurred in the cache device;
holding, in a case the error is an error in tag information, a predetermined lower address of a memory address of the memory where information associated with the directory where the error has been detected is stored;
determining, in a case a read request for information stored in the memory is received from another computer, whether a lower address of a memory address that is a target of the read request and the lower address that is being held match each other or not; and
controlling, in a case the lower address of the memory address that is the target of the read request and the lower address that is being held are determined not to match each other, coherency of the information that is a target of the read request, based on a directory of the information that is the target of the read request.
